(19) United States
(12) Patent Application Publication
(10) Pub. No.: US 2016/0274321 A1
(43) Pub. Date: Sep. 22, 2016

(54) Flexible Structured Optical Modules

(71) Applicant: II-VI Incorporated, Saxonburg, PA (US)

(72) Inventors: Ian Peter McClean, Brixham (UK); Aravanan Gurusami, Morgan Hill, CA (US); Richard Smart, Santa Clara, CA (US); Mark H. Garrett, Morgan Hill, CA (US); Mark Filipowicz, Scotts Valle, CA (US)

(73) Assignee: II-VI Incorporated, Saxonburg, PA (US)

(21) Appl. No.: 15/075,126

(22) Filed: Mar. 19, 2016

Related U.S. Application Data
(60) Provisional application No. 62/136,476, filed on Mar. 21, 2015.

(51) Int. Cl. G02B 6/42; G02B 6/36; G02B 6/12

(52) U.S. Cl. CPC G02B 6/4281; G02B 6/12004; G02B 6/4257; G02B 6/3608; G02B 2006/12135; G02B 2006/12069

(57) ABSTRACT

Optical modules as used in various types of communication systems are formed to include a flexible substrate to support various optical, electronic, and opto-electronic module components in a manner that can accommodate various packaging constraints. The flexible substrate is formed of a polyimide film is known to exhibit excellent electrical isolation properties, even though the films are generally relatively thin (on the order of 10-100 μms, in most cases). The flexible polyimide film is sized to accommodate the constraints of a given package “footprint”; more particularly, sized to fit an open ‘floor area’ within package, allowing for a populated film to be placed around various other “fixed-in-place” elements . The polyimide film is easily cut and trimmed to exhibit whatever topology is convenient, while providing enough surface area to support the affixed components and associated optical fiber traces.

### CROSS-REFERENCE TO RELATED APPLICATION

This application claims the benefit of U.S. Provisional Application Ser. No. 62/136,476, filed Mar. 21, 2015 and herein incorporated by reference.

### TECHNICAL FIELD

The present invention relates to optical modules as used in various types of communication systems and, more particularly, to the utilization of a flexible substrate to support various optical, electronic, and opto-electronic module components in a manner that can accommodate various packaging constraints.

### BACKGROUND OF THE INVENTION

Various configurations and components of optical communication systems have utilized “flexible” substrates (such as polyimide films) to support complicated patterns and topologies of optical fiber. In these systems, an adhesive-coated flexible substrate is provided and a length of optical fiber is pressed into a pressure-sensitive adhesive coating and routed across the surface of the flexible substrate in a configuration that is appropriate and efficient for the specific arrangement. Two-dimensional fiber arrangements have also been formed, with a first group of fibers routed along and attached to a first adhesive-coated substrate, and the first substrate then covered with a second sheet of the same material, and the fiber routing process repeated.

While the use of an adhesive-coated flexible sheet for maintaining large quantities of optical fiber in a fixed position is well-known and used, there remains the need to interconnect these “fiber sheets” with other optical components to form a desired optical module.

### SUMMARY OF THE INVENTION

The needs remaining in the prior art are addressed by the present invention, which relates to optical modules as used in various types of communication systems and, more particularly, to the utilization of a flexible substrate to support various optical, electronic, and opto-electronic module components in a manner that can accommodate various packaging constraints.

A flexible polyimide film is known to exhibit excellent electrical isolation properties, even though the films are generally relatively thin (on the order of 10-100 μms, in most cases). In the application of the present invention, the flexible polyimide film is sized to accommodate the constraints of a given package “footprint”; more particularly, sized to fit an open ‘floor area’ within package, allowing for a populated film to be placed around various other “fixed-in-place” elements (such as, for example, a line card element that has been previously soldered in place, a stand-alone pump source attached to a submount in a specific package location, etc.). The polyimide film is easily cut and trimmed to exhibit whatever topology is convenient, while providing enough surface area to support the affixed components and optical fiber (the fiber disposed as in the prior art, along traces formed in the adhesive coating).

In accordance with an exemplary embodiment of the present invention, the various individual optical components necessary to form a specific module (such as an amplifier, a channel monitor, a switch, etc.) are placed upon, and attached to, the same adhesive-coated flexible substrate material as the optical fiber.

In one exemplary configuration, the various passive and optical components necessary to form a specific module (e.g., lenses, filters, laser diodes, photodiodes, etc.) are positioned at appropriate locations on a pressure-sensitive adhesive coating and pressed down (slightly) so that the devices adhere to the adhesive coating on the surface of a flexible substrate. The associated fiber pigtails (as well as necessary electrical signal paths) are also affixed to the adhesive coating. Indeed, it is also possible to include necessary electrical components on the flexible substrate as well.

In another embodiment, multiple layers of adhesive-coated flexible substrate material may be disposed within a particular package so as to allow for different devices and configurations to be accommodated in a compact arrangement.

A specific embodiment of the present invention takes the form of an optical module comprising a plurality of optical components, a plurality of electro-optic components, sections of optical fiber interconnecting the plurality of optical components and the plurality of electro-optic components in a predetermined configuration, and a flexible substrate including an adhesive-coated surface layer, where the plurality of optical components and the plurality of electro-optic components are affixed to the adhesive-coated surface layer and the sections of optical fiber are disposed in paths formed within the adhesive-coated surface layer.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a top view of an exemplary adhesive-coated flexible substrate, with a plurality of optical components disposed in place on the surface of the flexible substrate;

FIG. 2 is a side view of an exemplary flexible substrate material;

FIG. 3 illustrates the configuration of FIG. 1 as disposed in place with related “fixed-in-place” elements; and

FIG. 4 is an alternative arrangement of FIG. 3, in this case using multiple layers of adhesive-coated flexible substrate material.

### DETAIL DESCRIPTION

The use of a flexible substrate material to support and connect various optical and electrical components of an optical module is considered to be an efficient and relatively inexpensive approach to creating any desired configuration of components in a manner that adheres to given packaging constraints. Various issues well-known in the art with respect to wasted space within a fixed-frame module, footprint requirements and dimension restrictions in certain environments, and the like, can all be easily addressed by the use of a flexible substrate, which may be form-fit to accommodate specific design requirements. Indeed, the shape of the flexible optical module made be easily managed to fit around other modules or elements found in a larger system (e.g., line cards and the like).

As with the two-dimensional fiber sheets, the configuration of the present invention is anticipated to also be able to use multiple layers of adhesive-coated flexible substrate material. Instead of using separate sheets of substrate material, multi-dimensional configuration may also be created by folding over the flexible substrate sheet (or bending the sheet as necessary). Additional elements for providing necessary heating and/or cooling of the structure may also be incorporated in the module, including for example, a heating element disposed in parallel with a section of doped fiber used in an optical amplifier. In configurations where cooling paths are required (such as, for example, when a laser diode is included as part of the optical module), a suitable type of cooler/thermal management element may also be included.

The use of an adhesive-coated flexible substrate allows for conventional “pick-and-place” robotic assembly systems to be used to attach the components to the adhesive surface, with other well-known arrangements used to route the fiber and adhere it to the flexible material. Of course, a manual assembly system may also be used.

Additionally, the use of a flexible film material as the “substrate” upon which an optical module is built allows for the module to be fully constructed, with its various components optically and electrically interconnected, prior to installing any portion of this module in an associated larger assembly. Said another way, an optical module formed on a flexible substrate can be first built, and then laid into place within a housing or packaging where the additional structures of final assembly are located. This approach removes the issue of current manufacturing processes that restrict fiber pigtail lengths to those that match the manufacturing equipment set-up and/or built-in winding form (as well as having to always accommodate the fixed locations of places and components within the mechanical housing).

In most conventional optical modules, the mechanical structure dictates the specific locations where the passive components, splices and fibers can be placed. Due to the risk of a failed splice, the various fiber pigtails have to be made longer than the minimum distance between components, in case a splice needs to be repaired. This results in increasing the fiber density within the module. Conventional arrangements also require that the fiber pigtails be positioned, wound and fit within very cramped and difficult to access locations between the fixed-in-place components.

The approach of the present invention addresses these concerns by allowing for the optical module to be assembled and all of the necessary fiber connections to be made prior to placing the “flexible” module within a larger mechanical housing structure. As a further benefit, the physical length of the fiber path from the input to the output of the optical module can be made relatively short. Thus, signal transfer latency through the module can be significantly reduced - a key parameter in various important optical communication applications.

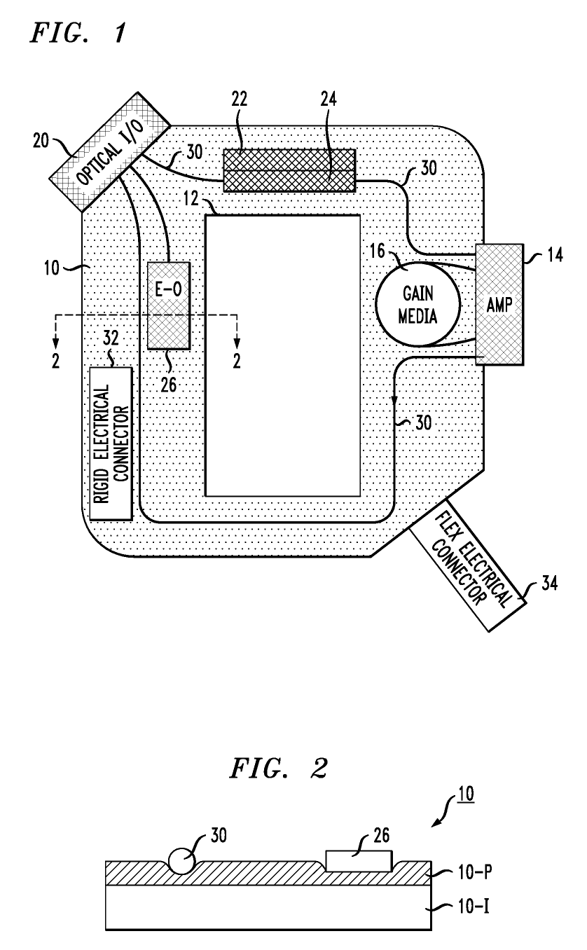

FIG. 1 is a top view of an exemplary flexible substrate material as populated with various components utilized in forming an optical module. In accordance with the present invention, an adhesive-coated flexible substrate 10 is used as the foundation upon which the remaining components are placed and attached. For example, a resin-coated sheet of material such as Kapton® polyimide film (supplied by DuPont, Inc.) is a typical choice for substrate 10, inasmuch as it includes a pressure-sensitive coating layer (shown as 10-P in the cut-away side view of FIG. 2) formed over a layer of insulative material 10-I. Pressure-sensitive polyimide film is typically available as a “sheet” of material, with a thickness on the order of 10-100 μms, and is relatively easy to use.

In the example shown in FIG. 1, flexible substrate 10 has been sliced through and cut to include an interior opening 12, which may be shaped to allow for another, separate system component (such as a reconfigurable optical add-drop multiplexer, ROADM) to be inserted, in a manner where flexible substrate 10 then surrounds the large component. In many cases, a component such as a ROADM may be a “fixed-in-place” element that is relatively large and requires specific placement within a larger optical system. Thus, as described above, by forming the optical module of the present invention on one or more sheets of flexible material that may be configured to accommodate various system layouts, a complete subsystem can first be assembled, and then inserted in place with other portions of a system in an efficient assembly procedure.

In the particular arrangement shown in FIG. 1, a fiber-based optical amplifier 14 is formed as a component that is adhered to adhesive-coated surface 10-P of flexible substrate 10. A coil of erbium-doped fiber 16 (shown as the ‘gain media’ in FIG. 1) for use with optical amplifier 14 is affixed to the adhesive surface of flexible substrate 10 at a convenient location next to amplifier 14 (with fiber pigtails 18 used to provide the optical connection between the doped fiber and the amplifier component). An optical input/output element 20 is shown as affixed to a portion of adhesive-coating 10-P of flexible substrate material 10. Also shown in FIG. 1 is a pair of conventional optical components 22, 24 (which may take the form of switches, multiplexers, etc.). An electro-optic component 26 is also shown in FIG. 1 as being affixed to the surface of flexible substrate 10, where this component may comprise an attenuator, tunable filter, laser diode pump source, etc., or any other device that includes an electrical input or output signal path.

As mentioned above, it is an aspect of the present invention that the various fiber interconnects required to couple together the components forming the module are routed along (and affixed to) surface coating 10-P of flexible substrate 10. Various fiber segments are shown as elements 30 in FIG. 1. An electrical connectors 32 is shown as an additional components in the optical module arrangement of FIG. 1, with a flexible-type of electrical connector 34 as used with various types of multi-element connection arrangements also being include. As with the optical components, these electrical components may be adhered to the pressure-sensitive adhesive coating layer 10-P of flexible material substrate 10.

FIG. 2 is a cut-away side view of the configuration of FIG. 1, taken along line 2-2. This view illustrates (not to scale) both the underlying insulative polyimide film 10-I of flexible substrate 10, as well as pressure-sensitive adhesive-coating layer 10-P. In this view, a portion of an optical fiber segment 30 and opto-electronic component 26 are shown as pressed into (and thus adhered to) coating layer 10-P of flexible substrate 10.

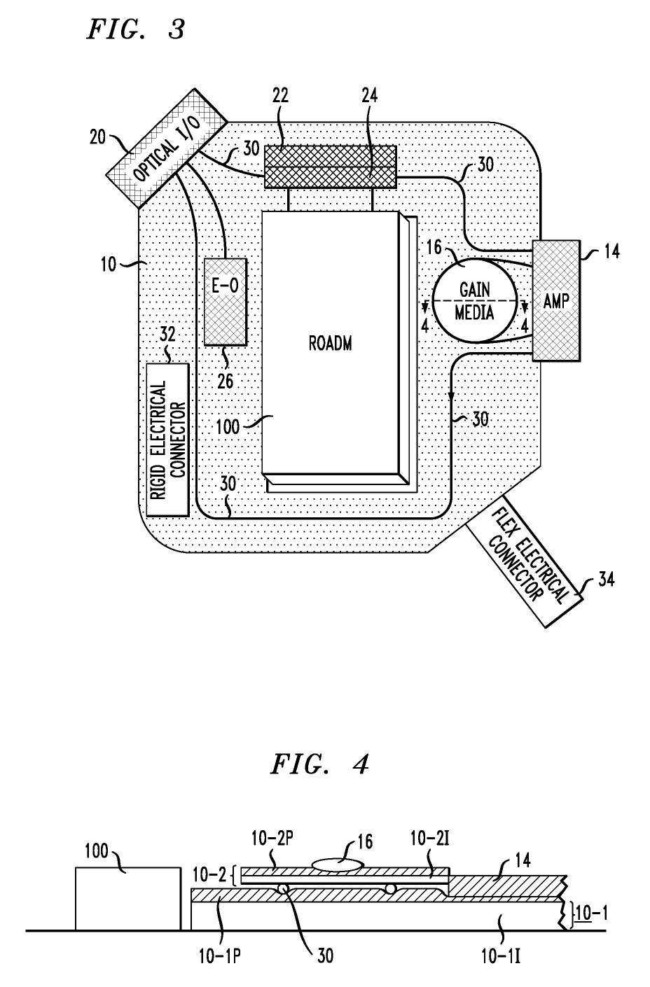

Once flexible substrate 10 has been fully populated with the desired components forming the optical module as shown in FIG. 1, flexible substrate 10 is then positioned within a larger mechanical structure (housing) that includes other functional modules. FIG. 3 shows the configuration of FIG. 1 as placed to surround a “fixed-in place” component 100, such as ROADM, that has previously been attached to a predetermined floor location within a larger mechanical structure 110. While flexible substrate 10 is shown here as a single, continuous sheet of material, it is to be understood that several separate pieces of adhesive-coated polyimide film may be used within different types of housing, each piece strategically placed so as to be able to contain all necessary components within a package having particular constraints in terms of its dimensions.

Besides using multiple, separate pieces of flexible substrate material across the “floor” of a particular package, it is also possible to use multiple layers of flexible substrate material to provide for a two-dimensional stacking of various components and/or fibers. FIG. 4 is a cut-away side view of a portion of FIG. 3, where the particular configuration as shown in FIG. 4 uses a second layer of flexible material (denoted as 10-2 in the illustration) to support the coil of doped fiber 16 associated with optical amplifier 14. In this case, all of the other fiber traces are formed in the lower layer of flexible substrate 10-1, and a separately-formed (typically, spun-on) coil of doped fiber is formed on a different sheet of flexible material and thereafter added to the other components forming the optical module. As mentioned above, other elements such as heaters, coolers, and the like may be included as well.

The examples and embodiments disclosed in this application are to be considered in all respects as illustrative and not limiting in terms of defining the scope of the present invention. That is, the scope of the invention is intended to be indicated by the appended claims rather than the foregoing description; and all changes which come within the meaning and range of equivalency of the claims are intended to be embraced therein.

What is claimed is:

1. An optical module comprising
a plurality of optical components;
a plurality of electro-optic components;
sections of optical fiber interconnecting the plurality of optical components and the plurality of electro-optic components in a predetermined configuration; and
a flexible substrate including an adhesive-coated surface layer, where the plurality of optical components and the plurality of electro-optic components are affixed to the adhesive-coated surface layer and the sections of optical fiber are disposed in paths formed within the adhesive-coated surface layer.

2. The optical module as defined in claim 1 wherein the flexible substrate is formed to include openings for accommodating additional system elements.

3. The optical module as defined in claim 2 wherein the additional system elements include fixed-in-place components.

4. The optical module as defined in claim 1 wherein the flexible substrate comprises multiple layers of flexible material disposed over one another.

5. The optical module as defined in claim 4 wherein at least one layer of flexible material supports a coil of optical fiber.

6. The optical module as defined in claim 5 wherein the coil of optical fiber comprises a coil of rare earth-doped optical fiber utilized for an optical amplifier.

7. The optical module as defined in claim 1 wherein the module further comprises at least one heater element affixed to the adhesive-coated surface layer of the flexible substrate.

8. The optical module as defined in claim 1 wherein the module further comprises at least one cooler element affixed to the adhesive-coated surface layer of the flexible substrate.

9. The optical module as defined in claim 1 wherein the adhesive-coated surface layer comprises a pressure-sensitive adhesive material.

10. The optical module as defined in claim 1 wherein the flexible substrate comprises a film of polyimide material.

11. An optical module comprising
a plurality of optical components;
a plurality of electro-optic components;
sections of optical fiber interconnecting the plurality of optical components and the plurality of electro-optic components in a predetermined configuration; and
a flexible substrate including an adhesive-coated surface layer, where the plurality of optical components and the plurality of electro-optic components are affixed to the adhesive-coated surface layer.

12. An optical module as defined in claim 11 wherein the sections of optical fiber are disposed in paths formed within the adhesive-coated surface layer.
